(19) United States
(12) Patent Application Publication
(10) Pub. No.: US 2026/0319679 A1
(43) Pub. Date: Oct. 15, 2026

(54) SYSTEMS AND METHODS OF BYTE-ADDRESSABLE NAND MEMORY

(71) Applicant: Samsung Electronics Co., Ltd., Suwon-si (KR)

(72) Inventors: Matthew BRYSON, Los Gatos, CA (US); Ho Bin LEE, San Jose, CA (US); Rekha PITCHUMANI, Oak Hill, VA (US)

(21) Appl. No.: 19/402,976

(22) Filed: Nov. 26, 2025

Related U.S. Application Data
(60) Provisional application No. 63/786,943, filed on Apr. 10, 2025.

(51) Int. Cl. G06F 3/06

(52) U.S. Cl. CPC G06F 3/0631; G06F 3/0608; G06F 3/0679

(57) ABSTRACT

Provided are systems, methods, and apparatuses for byte-addressable NAND memory. In one or more examples, the systems, devices, and methods include generating a first flash translation layer for a first allocation of a memory device; generating a second flash translation layer for a second allocation of the memory device, the first allocation and the second allocation being based on a pool of allocation space indicated in a freelist; and adding at least one of the first allocation or the second allocation to an allocation list based on generating at least one of the first flash translation layer or the second flash translation layer.

### CROSS-REFERENCE TO RELATED APPLICATIONS

This application claims the benefit of U.S. Provisional patent application Ser. No. 63/786,943, filed Apr. 10, 2025, which is incorporated by reference herein for all purposes.

### TECHNICAL FIELD

The disclosure relates generally to memory systems. In particular, the subject matter relates to byte-addressable NAND memory.

### BACKGROUND

The present background section is intended to provide context only, and the disclosure of any concept in this section does not constitute an admission that said concept is prior art.

Memory systems and storage systems can include NAND flash memory (“NAND”). NAND can include a non-volatile memory technology based on NAND flash memory chips that can retain data without requiring power. With NAND, a page can be the smallest unit of data, while a block can be the smallest unit of erase access. A page may be configured with some size (e.g., 4 kilobytes (KB) in size, 16 KB, 48 KB, 64 KB, etc.). Multiple pages (e.g., 128 pages) may be combined to form one block, where a block may be configured with some size (e.g., 512 KB). A block may be referred to as an erase unit. The size of a block or erase unit can determine the garbage collection (GC) granularity of NAND memory.

### SUMMARY

In various embodiments, the systems and methods described herein include systems, methods, and apparatuses for byte-addressable NAND memory. In some aspects, . . .

In some aspects, the techniques described herein relate to a method including: generating a first flash translation layer for a first allocation of a memory device; generating a second flash translation layer for a second allocation of the memory device, the first allocation and the second allocation being based on a pool of allocation space indicated in a freelist; and adding at least one of the first allocation or the second allocation to an allocation list based on generating at least one of the first flash translation layer or the second flash translation layer.

In some aspects, the techniques described herein relate to a method, further including: determining that the freelist indicates a requested number of blocks are available for the first allocation; and removing the requested number of blocks from the freelist for the first allocation, wherein allocations are provided by the freelist based on least recently used blocks.

In some aspects, the techniques described herein relate to a method, further including: polling a listing, at least one block from the third allocation.

In some aspects, the techniques described herein relate to a method, further including: scanning a block of a fourth allocation for values written to pages of the block; clearing the block based on a number of pages of the block satisfying a written pages threshold; and adding the block to the freelist based on clearing the block.

In some aspects, the techniques described herein relate to a method, further including: determining a number of pages used by a third allocation is less than a number of pages allocated to the third allocation; and transferring at least one of the pages used by the third allocation from a first block of the third allocation to a second block of the third allocation.

In some aspects, the techniques described herein relate to a method, further including: adding the first block of the third allocation to the freelist based on freeing the first block of the third allocation; and updating a flash translation layer of the third allocation based on the transferring the at least one of the pages and the adding the first block of the third allocation to the freelist.

In some aspects, the techniques described herein relate to a method, further including: determining a number of invalid pages satisfies a garbage collection threshold; transferring pages of a first block and a second block of a fifth allocation to a third block of the sixth allocation; and adding the first block and the second block of the fifth allocation to the freelist.

In some aspects, the techniques described herein relate to a method, further including: scanning the freelist based on the freelist indicating memory space available for allocations; determining a number of deleted pages satisfies a garbage collection threshold; transferring pages of a first block and a second block of a sixth allocation to a third block of the sixth allocation; and adding the first block and the second block of the sixth allocation to the freelist.

In some aspects, the techniques described herein relate to a method, further including: storing a value in a first page of the first allocation; and storing a pointer to the value in a second page of the first allocation based on a second instance of the value being used by an application associated with the first allocation.

In some aspects, the techniques described herein relate to a method, wherein an allocation controller of the memory device generates flash translation layers of the memory device.

In some aspects, the techniques described herein relate to a method, wherein: a memory controller of the memory device generates flash translation layers of the memory device, and the memory device includes a NAND flash memory device.

In some aspects, the techniques described herein relate to a method, wherein: the freelist includes a list of blocks available for allocation, and the allocation list includes a list of blocks being allocated.

In some aspects, the techniques described herein relate to a device including: one or more processors; and memory storing instructions that, when executed by the one or more processors, cause the device to: generate a first flash translation layer for a first allocation of a memory device; generate a second flash translation layer for a second allocation of the memory device, the first allocation and the second allocation being based on a pool of allocation space indicated in a freelist; and add at least one of the first allocation or the second allocation to an allocation list based on generating at least one of the first flash translation layer or the second flash translation layer.

In some aspects, the techniques described herein relate to a device, wherein the instructions, when executed by the one or more processors, further cause the device to: determine that the freelist indicates a requested number of blocks are available for the first allocation; and remove the requested number of blocks from the freelist for the first allocation, wherein allocations are provided by the freelist based on round-robin scheduling.

In some aspects, the techniques described herein relate to a device, wherein the instructions, when executed by the one or more processors, further cause the device to: poll a list, for the second allocation, at least one block from the third allocation.

In some aspects, the techniques described herein relate to a device, wherein the instructions, when executed by the one or more processors, further cause the device to: scan a block of a fourth allocation for values written to pages of the block; clear the block based on a number of pages of the block satisfying a written pages threshold; and add the block to the freelist based on clearing the block.

In some aspects, the techniques described herein relate to a device, wherein the instructions, when executed by the one or more processors, further cause the device to: determine a number of pages used by a third allocation is less than a number of pages allocated to the third allocation; and transfer at least one of the pages used by the third allocation from a first block of the third allocation to a second block of the third allocation.

In some aspects, the techniques described herein relate to a non-transitory computer-readable medium storing code that includes instructions executable by a processor of to: generate a first flash translation layer for a first allocation of a memory device; generate a second flash translation layer for a second allocation of the memory device, the first allocation and the second allocation being based on a pool of allocation space indicated in a freelist; and add at least one of the first allocation or the second allocation to an allocation list based on generating at least one of the first flash translation layer or the second flash translation layer.

In some aspects, the techniques described herein relate to a non-transitory computer-readable medium, wherein the code includes further instructions executable by the processor to: determine that the freelist indicates a requested number of blocks are available for the first allocation; and remove the requested number of blocks from the freelist for the first allocation, wherein allocations are provided by the freelist based on round-robin scheduling.

In some aspects, the techniques described herein relate to a non-transitory computer-readable medium, wherein the code includes further instructions executable by the processor to: poll a list, for the second allocation, at least one block from the third allocation.

A computer-readable medium is disclosed. The computer-readable medium can store instructions that, when executed by a computer, cause the computer to perform substantially the same or similar operations as described herein are further disclosed. Similarly, non-transitory computer-readable media, devices, and systems for performing substantially the same or similar operations as described herein are further disclosed.

The systems and methods of byte-addressable NAND memory described herein include multiple advantages and benefits. For example, the systems and methods may enable NAND to be configured as a byte addressable memory, providing a cost-effective byte-addressable memory, NAND being considerably lower in cost compared to dynamic random-access memory (DRAM). Also, the systems and methods improve performance with block level contiguous allocations, which may speed up other systems (e.g., based on prefetching). Also, the systems and methods may keep allocations distinct rather than polluting a common flash translation layer (FTL) with all allocations that have disparate lifetimes. Additionally, the systems and methods enable reduced metadata overhead for NAND used in multiple allocations. Also, the systems and methods allow for a relatively quick allocation scheme for NAND in a memory environment. Additionally, the systems and methods may provide metadata bits that reduce active page writes and reduce NAND wear. Also, the systems and methods may provide metadata that enables data to occupy less than the physical space on the device.

### BRIEF DESCRIPTION OF THE DRAWINGS

The above-mentioned aspects and other aspects of the present systems and methods will be better understood when the present application is read in view of the following FIGURES in which like numbers indicate similar or identical elements. Further, the drawings provided herein are for purpose of illustrating certain embodiments only; other embodiments, which may not be explicitly illustrated, are not excluded from the scope of this disclosure.

These and other features and advantages of the present disclosure will be appreciated and understood with reference to the specification, claims, and appended drawings, wherein:

FIG. 1 illustrates an example system in accordance with one or more implementations as described herein.

FIG. 2 illustrates details of the system of FIG. 1, according to one or more implementations as described herein.

FIG. 3 illustrates an example system in accordance with one or more implementations as described herein.

FIG. 4 illustrates example data blocks in accordance with one or more implementations as described herein.

FIG. 5 depicts a flow diagram illustrating an example method associated with the disclosed systems, in accordance with example implementations described herein.

FIG. 6 depicts a flow diagram illustrating an example method associated with the disclosed systems, in accordance with example implementations described herein.

FIG. 7 depicts a flow diagram illustrating an example method associated with the disclosed systems, in accordance with example implementations described herein.

FIG. 8 depicts a flow diagram illustrating an example method associated with the disclosed systems, in accordance with example implementations described herein.

FIG. 9 depicts a flow diagram illustrating an example method associated with the disclosed systems, in accordance with example implementations described herein.

FIG. 10 depicts a flow diagram illustrating an example method associated with the disclosed systems, in accordance with example implementations described herein.

While the present systems and methods are susceptible to various modifications and alternative forms, specific embodiments thereof are shown by way of example in the drawings and will herein be described. The drawings may not be to scale. It should be understood, however, that the drawings and detailed description thereto are not intended to limit the present systems and methods to the particular form disclosed, but to the contrary, the intention is to cover all modifications, equivalents, and alternatives falling within the spirit and scope of the present systems and methods as defined by the appended claims.

### DETAILED DESCRIPTION OF VARIOUS EMBODIMENTS

The details of one or more embodiments of the subject matter described herein are set forth in the accompanying drawings and the description below. Other features, aspects, and advantages of the subject matter will become apparent from the description, the drawings, and the claims.

Various embodiments of the present disclosure now will be described more fully hereinafter with reference to the accompanying drawings, in which some, but not all embodiments are shown. Indeed, the disclosure may be embodied in many forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout. Arrows in each of the FIGURES depict bi-directional data flow and/or bi-directional data flow capabilities. The terms “path,” “pathway” and “route” are used interchangeably herein.

Embodiments of the present disclosure may be implemented in various ways, including as computer program products that comprise articles of manufacture. A computer program product may include a non-transitory computer-readable storage medium storing applications, programs, program components, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media includes all computer-readable media (including volatile and non-volatile media).

In one embodiment, a non-volatile computer-readable storage medium may include a floppy disk, flexible disk, hard disk, solid-state storage (SSS) (for example a solid-state drive (SSD)), solid state card (SSC), solid state module (SSM), enterprise flash drive, magnetic tape, or any other non-transitory magnetic medium, and/or the like. A non-volatile computer-readable storage medium may include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may include read-only memory (ROM), programmable read-only memory (PROM), erasable programmable read-only memory (EPROM), electrically erasable programmable read-only memory (EEPROM), flash memory (for example Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may include conductive-bridging random-access memory (CBRAM), phase-change random-access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random-access memory (FJG RAM), Millipede memory, racetrack memory, and/or the like.

In one embodiment, a volatile computer-readable storage medium may include random-access memory (RAM), dynamic random-access memory (DRAM), static random-access memory (SRAM), fast page mode dynamic random-access memory (FPM DRAM), extended data-out dynamic random-access memory (EDO DRAM), synchronous dynamic random-access memory (SDRAM), double data rate synchronous dynamic random-access memory (DDR SDRAM), double data rate type two synchronous dynamic random-access memory (DDR2 SDRAM), double data rate type three synchronous dynamic random-access memory (DDR3 SDRAM), Rambus dynamic random-access memory (RDRAM), Twin Transistor RAM (TTRAM), Thyristor RAM (T-RAM), Zero-capacitor (Z-RAM), Rambus in-line memory component (RIMM), dual in-line memory component (DIMM), single in-line memory component (SIMM), video random-access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of a hardware embodiment, a computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, a hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially, such that one instruction is retrieved, loaded, and executed at a time. In some examples, retrieval, loading, and/or execution may be performed in parallel, such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not be necessarily all referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms, and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms, and a plural term may include the corresponding singular form. It is further noted that various FIGURES (including component diagrams) shown and discussed herein are for illustrative purpose only, and are not drawn to scale. Similarly, various waveforms and timing diagrams are shown for illustrative purpose only. For example, the dimensions of some of the elements may be exaggerated relative to other elements for clarity. Further, if considered appropriate, reference numerals have been repeated among the FIGURES to indicate corresponding and/or analogous elements.

The terminology used herein is for the purpose of describing some embodiments and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more FIGURES to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly referenced parts/modules are the only way to implement some of the embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on chip (SoC), an assembly, and so forth.

The provided description is presented to enable one of ordinary skill in the art to make and use the subject matter disclosed herein and to incorporate it in the context of particular applications. While the following is directed to specific examples, other and further examples may be devised without departing from the basic scope thereof.

Various modifications, as well as a variety of uses in different applications, will be readily apparent to those skilled in the art, and the general principles defined herein may be applied to a wide range of embodiments. Thus, the subject matter disclosed herein is not intended to be limited to the embodiments presented, but is to be accorded the widest scope consistent with the principles and novel features disclosed herein.

In the description provided, numerous specific details are set forth in order to provide a more thorough understanding of the subject matter disclosed herein. It will, however, be apparent to one skilled in the art that the subject matter disclosed herein may be practiced without necessarily being limited to these specific details. In other instances, well-known structures and devices are shown in block diagram form, rather than in detail, in order to avoid obscuring the subject matter disclosed herein.

All the features disclosed in this specification (e.g., any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Various features are described herein with reference to the FIGURES. It should be noted that the FIGURES are only intended to facilitate the description of the features. The various features described are not intended as an exhaustive description of the subject matter disclosed herein or as a limitation on the scope of the subject matter disclosed herein. Additionally, an illustrated example need not have all the aspects or advantages shown. An aspect or an advantage described in conjunction with a particular example is not necessarily limited to that example and can be practiced in any other examples, even if not so illustrated, or if not so explicitly described.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

It is noted that, if used, the labels left, right, front, back, top, bottom, forward, reverse, clockwise and counterclockwise have been used for convenience purposes only and are not intended to imply any particular fixed direction. Instead, the labels are used to reflect relative locations and/or directions between various portions of an object.

Data processing may include data buffering, aligning incoming data from multiple communication lanes, forward error correction (FEC), etc. For example, data may be received by an analog front end (AFE), which can prepare the incoming data for digital processing. The digital portion of the transceivers (e.g., digital signal processor (DSP)) may provide skew management, equalization, reflection cancellation, and/or other functions. It is to be appreciated that the process described herein can provide many benefits, including saving both power and cost.

Moreover, the terms “system,” “component,” “module,” “interface,” “model,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution, and a component may be localized on one computer and/or distributed between two or more computers.

Unless explicitly stated otherwise, each numerical value and range may be interpreted as being approximate, as if the word “about” or “approximately” preceded the value of the value or range. Signals and corresponding nodes or ports might be referred to by the same name and are interchangeable for purposes here.

While embodiments may have been described with respect to circuit functions, the embodiments of the subject matter disclosed herein are not limited. Possible implementations may be embodied in a single integrated circuit, a multi-chip module, a single card, SoC, or a multi-card circuit pack. As would be apparent to one skilled in the art, the various embodiments might also be implemented as part of a larger system. Such embodiments may be employed in conjunction with, for example, a digital signal processor, microcontroller, field-programmable gate array, application-specific integrated circuit, or general-purpose computer.

As would be apparent to one skilled in the art, various functions of circuit elements may also be implemented as processing blocks in a software program. Such software may be employed in, for example, a digital signal processor, microcontroller, or general-purpose computer. Such software may be embodied in the form of program code embodied in tangible media, such as magnetic recording media, optical recording media, solid-state memory, floppy diskettes, CD-ROMs, hard drives, or any other non-transitory machine-readable storage medium, that when the program code is loaded into and executed by a machine, such as a computer, the machine becomes an apparatus for practicing the subject matter disclosed herein. When implemented on a general-purpose processor, the program code segments combine with the processor to provide a unique device that operates analogously to specific logic circuits. Described embodiments may also be manifest in the form of a bit stream or other sequence of signal values electrically or optically transmitted through a medium, stored magnetic-field variations in a magnetic recording medium, etc., generated using a method and/or an apparatus as described herein.

The systems and methods described herein may include and/or may be based on NAND flash memory. In some cases, the systems and methods described herein may include and/or may be based on a flash translation layer (FTL), which may include a software layer and/or firmware layer that may be configured to manage the memory operations of the NAND flash (e.g., address translation, wear-leveling, garbage collection, bad block management, etc.). In some cases, the FTL may present a logical block device interface to a host system. A NAND flash block may include some number of pages (e.g., 64 pages, 128 pages, etc.). A given page may include some amount of data (e.g., 2,048 bytes). In some cases, a page may include a spare area (e.g., a 64-byte spare area) that may be used for error correction code (ECC), wear leveling information, etc.

Memory such as dynamic random-access memory (DRAM) may be byte-addressable. In byte-addressable memory systems, a byte in memory may be assigned an address, enabling the computer to access and modify data at the byte level. In some cases, NAND may not be byte-addressable. As a result of being non-byte addressable and having a mismatch in size between a page size and a GC unit, some systems of NAND may not allow for in place updates of data stored in the NAND. In some systems, FTL may be configured for long-term storage of data, which may not be applicable for all types of data.

The systems and methods described herein enable use of NAND as a byte addressable memory based on the interception of write commands and the modification of NAND block allocation for data in write commands. The systems and methods of byte-addressable NAND may provide for in place updates of data stored on a NAND. In some embodiments, the systems and methods described herein may involve linking the lifespan of the FTL to an associated allocation, thereby optimizing memory management and reducing overhead. In some cases, the systems and methods described may be based on implementing a minimum allocation size of a block to improve data locality and ease cleanup on free. In some cases, the systems and methods allow for usage of NAND in a byte addressable manner while preserving a mechanism of wear leveling. For example, wear-leveling may be implemented by ensuring a round robin allocation scheme of blocks in a freelist (e.g., list of NAND blocks available for allocation).

Based on the systems and methods described, byte addressable NAND may provide direct byte addressable (e.g., load/store) memory access. The disclosed systems and methods can be implemented in various configurations, including being executed by a host, a memory device, or a combination of both, thereby providing flexibility in different operational environments. In some cases, the systems and methods described may avoid unnecessary and common writes by performing pattern matching on incoming writes and only storing repeat values once (e.g., a memset command across a large memory region), and add additional page metadata to manage pattern matching. The same value could be stored multiple times across multiple blocks. If the value is updated, then each of these blocks would have to be copied to new blocks to reflect the updated value. By storing the value in one block and using metadata to indicate repeated copies of the same value (e.g., and pointers to the one block), an update of the value would result in copying the updated value to a single block and updating the metadata (e.g., and pointers) accordingly.

Accordingly, the systems and methods described herein enable the use of NAND memory as a byte-addressable memory medium, rather than as traditional block storage. For example, the systems and methods described herein enable direct byte-addressable load/store operations on NAND, which may not be natively supported due to NAND's inability to perform in-place updates.

The systems and methods described herein provide per-allocation flash translation layer (FTL). Instead of maintaining a device-level FTL, an FTL may be created and maintained for each memory allocation. A given per-allocation FTL may be maintained for the lifetime of the allocation, reducing metadata overhead and improving efficiency of memory management. A given per-allocation FTL may be generated by a controller on the NAND device and/or by a controller on a host of the NAND device.

The systems and methods described herein also provide block-aligned allocation and/or least recently used wear leveling. Allocations are aligned to the size of a NAND block, and a round-robin or least-recently-used free list allocator may be used to distribute wear evenly across blocks. The systems and methods described herein also provide repeat value bypass using metadata. A mechanism is introduced to represent repeated values (e.g., set by memset operations) in metadata, rather than physically writing them to NAND, which reduces unnecessary write and erase cycles, thereby extending NAND lifespan and improving performance.

The systems and methods described herein also provide flexible metadata management. Metadata for allocations, including page status (e.g., active, deleted, unused, or repeat value), can be stored in the NAND controller and/or on the host. The systems and methods described herein also provide efficient compaction and partial free operations. The system supports efficient compaction and partial freeing of allocations by tracking live and invalid pages (e.g., deleted pages), allowing for reclamation and reuse of blocks with minimal overhead. The systems and methods described herein also provide reduction of metadata overhead.

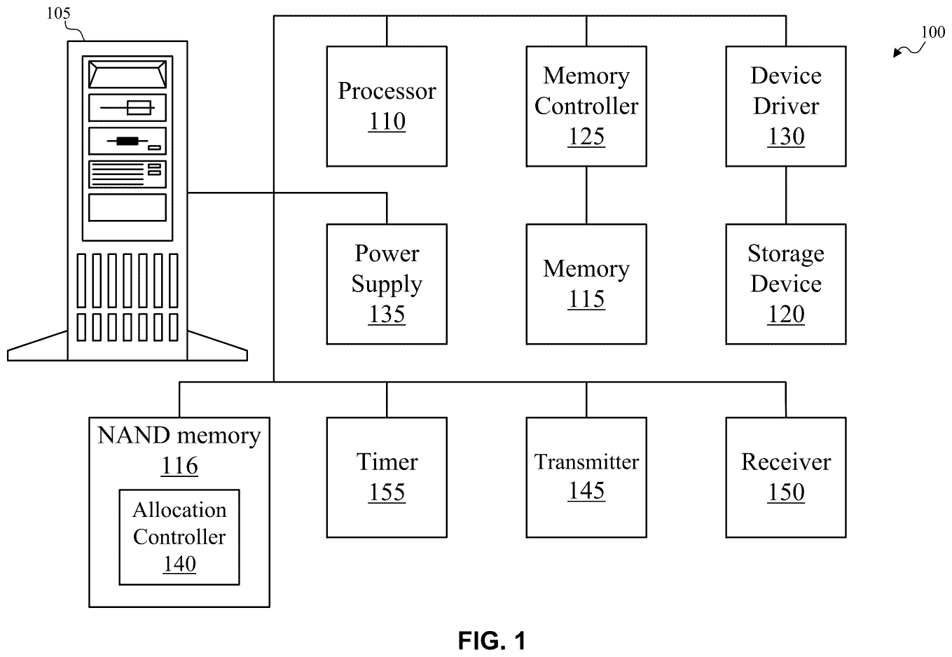

FIG. 1 illustrates an example system 100 in accordance with one or more implementations as described herein. In FIG. 1, machine 105, which may be termed a host, a system, or a server, is shown. While FIG. 1 depicts machine 105 as a tower computer, embodiments of the disclosure may extend to any form factor or type of machine. For example, machine 105 may be a rack server, a blade server, a desktop computer, a tower computer, a mini tower computer, a desktop server, a laptop computer, a notebook computer, a tablet computer, etc.

Machine 105 may include processor 110, memory 115, NAND memory 116, and storage device 120. Processor 110 may be any variety of processor. It is noted that processor 110, along with the other components discussed below, are shown outside the machine for ease of illustration: embodiments of the disclosure may include these components within the machine. While FIG. 1 shows a single processor 110, machine 105 may include any number of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115 may be any variety of memory, such as flash memory, DRAM, SRAM, Persistent Random-access memory, Ferroelectric Random-access memory (FRAM), or Non-Volatile Random-access memory (NVRAM), such as Magnetoresistive Random-access memory (MRAM), Phase Change Memory (PCM), or Resistive Random-Access Memory (ReRAM). Memory 115 may include volatile and/or non-volatile memory. Memory 115 may use any desired form factor: for example, Single In-Line Memory Module (SIMM), Dual In-Line Memory Module (DIMM), Non-Volatile DIMM (NVDIMM), etc. Memory 115 may be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may support an operating system under which various applications may be running. These applications may issue requests (which may be termed commands) to read data from or write data to either memory 115 or storage device 120. When storage device 120 is used to support applications reading or writing data via some sort of file system, storage device 120 may be accessed using device driver 130. While FIG. 1 shows one storage device 120, there may be any number (one or more) of storage devices in machine 105. Storage device 120 may support any desired protocol or protocols, including, for example, the Non-Volatile Memory Express (NVMe®) protocol, a Serial Attached Small Computer System Interface (SCSI) (SAS) protocol, or a Serial AT Attachment (SATA) protocol. Storage device 120 may include any desired interface, including, for example, a Peripheral Component Interconnect Express (PCIe®) interface, or a Compute Express Link (CXL®) interface. Storage device 120 may take any desired form factor, including, for example, a U.2 form factor, a U.3 form factor, a M.2 form factor, Enterprise and Data Center Standard Form Factor (EDSFF) (including all of its varieties, such as E1 short, E1 long, and the E3 varieties), or an Add-In Card (AIC).

While FIG. 1 uses the term “storage device,” embodiments of the disclosure may include any storage device formats that may benefit from the use of computational storage units, examples of which may include hard disk drives, Solid State Drives (SSDs), or persistent memory devices, such as PCM, ReRAM, or MRAM. Any reference to “storage device” “SSD” below should be understood to include such other embodiments of the disclosure and other varieties of storage devices. In some cases, the term “storage unit” may encompass storage device 120 and memory 115. Machine 105 may include power supply 135. Power supply 135 may provide power to machine 105 and its components.

Machine 105 may include transmitter 145 and receiver 150. Transmitter 145 or receiver 150 may be respectively used to transmit or receive data. In some cases, transmitter 145 and/or receiver 150 may be used to communicate with memory 115 and/or storage device 120.

In the illustrated example, machine 105 may include timer 155, which may be used to time one or more operations, indicate or measure a time period (e.g., of an allocation), indicate a lapse of time (e.g., of an allocation), indicate an expiration (e.g., of an allocation), indicate a timeout (e.g., of an allocation), etc.

In one or more examples, machine 105 may be implemented with any type of apparatus. Machine 105 may be configured as (e.g., as a host of) one or more servers, such as a compute server, a storage server, storage node, a network server, a supercomputer, data center system, and/or the like, or any combination thereof. Additionally, or alternatively, machine 105 may be configured as (e.g., as a host of) one or more computers, such as a workstation, a personal computer, a tablet, a smartphone, and/or the like, or any combination thereof. Machine 105 may be implemented with any type of apparatus that may be configured as a device including, for example, an accelerator device, a storage device, a network device, a memory expansion and/or buffer device, a central processing unit (CPU), a graphics processing unit (GPU), a neural processing unit (NPU), a tensor processing unit (TPU), optical processing units (OPU), and/or the like, or any combination thereof.

Any communication between devices including machine 105 (e.g., host, computational storage device, and/or any intermediary device) can occur over an interface that may be implemented with any type of wired and/or wireless communication medium, interface, protocol, and/or the like including PCIe, NVMe, Ethernet, NVMe-OF, Compute Express Link (CXL), and/or a coherent protocol such as CXL.mem, CXL.cache, CXL.IO and/or the like, Gen-Z, Open Coherent Accelerator Processor Interface (OpenCAPI), Cache Coherent Interconnect for Accelerators (CCIX), Advanced extensible Interface (AXI) and/or the like, or any combination thereof, Transmission Control Protocol/Internet Protocol (TCP/IP), FibreChannel, InfiniBand, Serial AT Attachment (SATA), Small Computer Systems Interface (SCSI), Serial Attached SCSI (SAS), iWARP, any generation of wireless network including 2G, 3G, 4G, 5G, and/or the like, any generation of Wi-Fi, Bluetooth, near-field communication (NFC), and/or the like, or any combination thereof. In some embodiments, the communication interfaces may include a communication fabric including one or more links, buses, switches, hubs, nodes, routers, translators, repeaters, and/or the like. In some embodiments, system 100 may include one or more additional apparatus having one or more additional communication interfaces.

Any of the functionality described herein, including any of the host functionality, device functionally, component functionality, and/or the like, may be implemented with hardware, software, firmware, or any combination thereof including, for example, hardware and/or software combinational logic, sequential logic, timers, counters, registers, state machines, volatile memories such as at least one of or any combination of the following: DRAM and/or SRAM, nonvolatile memory including flash memory, persistent memory such as cross-gridded nonvolatile memory, memory with bulk resistance change, PCM, and/or the like and/or any combination thereof, complex programmable logic devices (CPLDs), field programmable gate arrays (FPGAs), application specific integrated circuits (ASICs), CPUs including CISC processors such as x86 processors and/or RISC processors such as RISC-V and/or advanced RISC machine (ARM) processors, GPUs, NPUs, TPUs, OPUs, and/or the like, executing instructions stored in any type of memory.

Processor 110 may be coupled to NAND memory 116. NAND memory 116 may include NAND flash memory and/or one or more types of memory similar to memory 115. As shown, NAND memory 116 may include allocation controller 140. In some examples, allocation controller 140 may include logic (e.g., logic circuit, electrical circuit), hardware (e.g., processing unit, memory, storage), software, firmware, and the like. In some cases, allocation controller 140 may perform one or more functions in conjunction with processor 110. In some cases, at least a portion of allocation controller 140 may be implemented in or by processor 110 and/or memory 115. The one or more logic circuits of allocation controller 140 may include any one or combination of multiplexers, registers, logic gates, arithmetic logic units (ALUs), cache, computer memory, microprocessors, processing units (CPUs, GPUs, NPUs, and/or TPUs), FPGAs, ASICS, etc., that enable allocation controller 140 to provide byte-addressable NAND memory. Allocation controller 140 may be implemented in a host (e.g., machine 105) and/or in a memory device (e.g., memory 115, memory controller 125, storage device 120). In some embodiments, one or more components of allocation controller 140 may be implemented as an SoC.

In one or more examples, allocation controller 140 may enable byte-addressable NAND memory. For example, allocation controller 140 may enable NAND to be configured as a byte addressable memory, providing a cost-effective byte-addressable memory. Allocation controller 140 may improve performance of a given system with block level contiguous allocations, which may speed up other systems (e.g., based on prefetching). Also, allocation controller 140 may manage flash translation layers (FTLs) based on allocations, managing a first FTL to a first allocation, managing a second FTL to a second allocation, etc. Additionally, the systems and methods enable reduced metadata overhead for NAND used in multiple allocations. Additionally, allocation controller 140 may provide metadata bits that reduce active page writes and reduce NAND wear, and/or provide metadata that enables data to occupy less than the physical space on a given device.

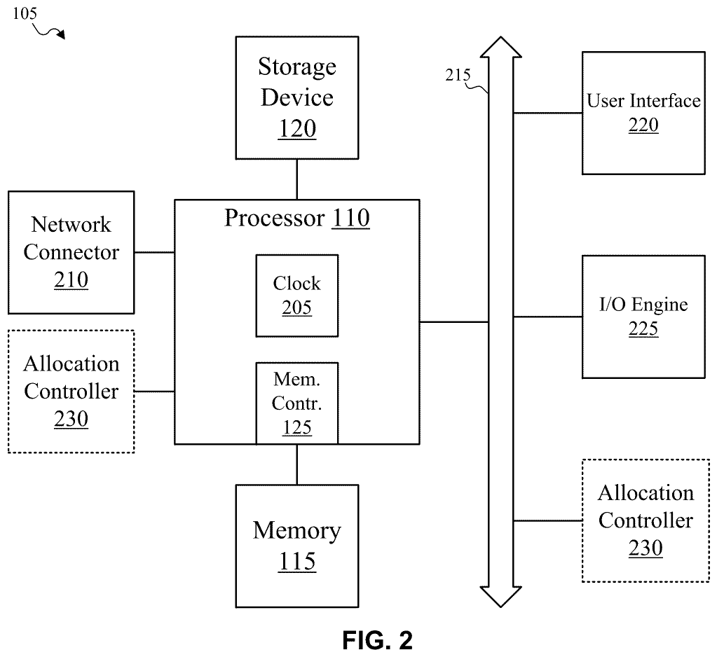

FIG. 2 illustrates details of machine 105 of FIG. 1, according to examples described herein. In the illustrated example, machine 105 may include processor 110. Processor 110 may include one or more processors and/or one or more dies. Processor 110 may include memory controller 125 (e.g., one or more memory controllers) and clock 205 (e.g. one or more clocks), which may be used to coordinate the operations of the components of the machine. Processor 110 may be coupled to memory 115 (e.g., one or more memory chips, stacked memory, etc.), which may include random-access memory (RAM), read-only memory (ROM), or other state preserving media, as examples. Processor 110 may be coupled to storage device 120 (e.g., one or more storage devices), and to network connector 210, which may be, for example, an Ethernet connector or a wireless connector. Processor 110 may be connected to bus 215 (e.g., one or more buses), to which may be attached user interface 220 (e.g., one or more user interfaces) and Input/Output (I/O) interface ports that may be managed using I/O engine 225 (e.g., one or more I/O engines), among other components. As shown, processor 110 may be coupled to allocation controller 230, which may be an example of allocation controller 140 of FIG. 1. Additionally, or alternatively, processor 110 may be connected to bus 215, to which may be attached allocation controller 230.

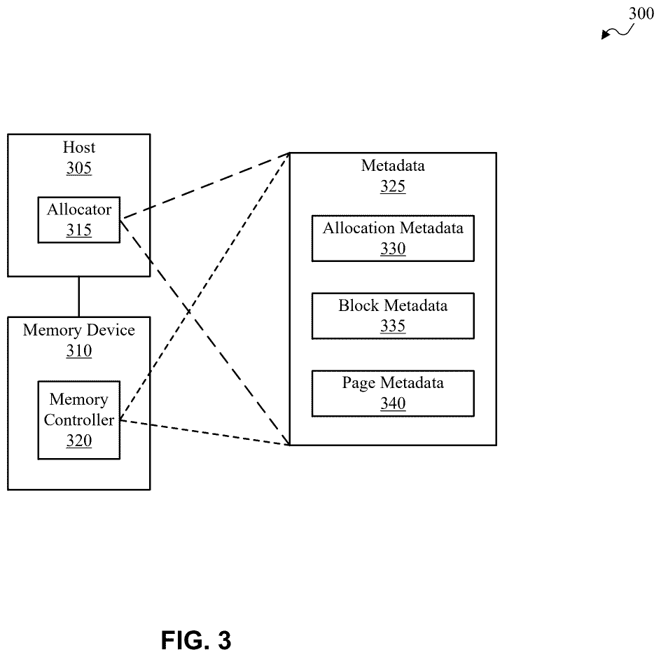

FIG. 3 illustrates an example system 300 in accordance with one or more implementations as described herein. In some configurations, one or more aspects of system 300 may be implemented by or in conjunction with allocation controller 140 of FIG. 1 and/or allocation controller 230 of FIG. 2. In some configurations, one or more aspects of system 300 may be implemented by or in conjunction with machine 105, components of machine 105, or any combination thereof.

In the illustrated example, system 300 may include host 305 and memory device 310. Memory device 310 may include volatile memory (e.g., DRAM memory) and/or non-volatile memory (e.g., NAND memory). Memory device 310 may be an example of memory 115 and/or NAND memory 116 of FIG. 1. Host 305 may include allocator 315 and memory device 310 may include memory controller 320. Host 305 may be an example of machine 105 of FIG. 1 and/or FIG. 2. Memory device 310 may be an example of memory 115 and/or NAND memory 116. Allocator 315 may be an example of allocation controller 140 of FIG. 1 and/or allocation controller 230 of FIG. 2. Memory controller 320 may be an example of memory controller 125, of allocation controller 140 of FIG. 1, and/or allocation controller 230 of FIG. 2.

As shown, system 300 may include metadata 325. Metadata 325 may include allocation metadata 330, block metadata 335, and page metadata 340. Allocation metadata 330 may include an allocation list (e.g., a list of active allocations). Block metadata 335 may include a freelist (e.g., a list of one or more blocks free for allocation). Page metadata 340 may include data regarding pages of a given block (e.g., pointers to other pages of the same block or another block, pointers to repeat data, indicator whether page is valid or invalid, indicator whether page is simulated, indicator whether page is empty, etc.).

Metadata 325 may be implemented in, stored in, and/or managed by allocator 315. Additionally, or alternatively, metadata 325 may be implemented in, stored in, and/or managed by memory controller 320. For example, metadata may be stored in memory device 310 and managed by allocator 315 and/or memory controller 320. Additionally, or alternatively, metadata 325 may be stored in memory device 310 and managed by allocator 315 and/or memory controller 320. In some cases, metadata 325 may be stored in another memory device or another storage device of host 305 (e.g., memory 115, storage device 120) and managed by allocator 315 and/or memory controller 320.

Table 1 illustrates an example of data that block metadata 335 may include.

TABLE 1

| Block # | Allocated | Used (Delete Required) |
|---|---|---|
| 0000 | 0b - Unallocated | 1b - True |
| 0001 | 1b - Allocated | 1b - False |
| . . . n | 0b - Unallocated | 1b - False |

Table 1 may depict at least one way how a freelist may be tracked. In some cases, the freelist may be configured as a linked-list in memory (e.g., memory of whichever device is managing the allocation, of host 305, and/or of memory device 310).

As shown, table 1 indicates a block number, indicates whether a block is allocated (e.g., logical 0 indicates unallocated, logical 1 indicates allocated, or vice versa), and/or indicates whether the block is used (e.g., logical 0 indicates unused, logical 1 indicates used, or vice versa). Table 1 may be used to prepare blocks for use in a requested allocation. In some alternative embodiments, metadata of table 1 may indicate a usage level for blocks. For example, the metadata may indicate how many of the pages in a given block have been consumed so that the managing system (e.g., host 305 and/or memory device 310) may determine whether to erase the block or to use the block based on the remaining space in the unwritten pages of a given block. In some cases, the managing system may erase the block or use the block based on the managing system analyzing the metadata to determine the page validity of one or more pages in the block, repeated data associated with the block, etc.

Table 2 illustrate an example of data that page metadata 340 may include.

TABLE 2

| Page Valid | | Repeat | |
|---|---|---|---|
| (2-bit) | Single Value Set | Value | Data |
| 0b - Invalid | 0b - No repeat data | 0x0 | Unwritten (page clear) |
| 1b - Active | 1b - Repeat Data | 0x1 | Unwritten (page clear) |
| 1b - Active | 0b - No repeat data | 0x0 | 1 page of data |
| 2b - Unused | 0b - No repeat data | N/A | Unwritten (page clear) |

As shown, the page validity bits of Table 2 (e.g., 2-bit indicator, binary 00) indicates the page associated with the first row is invalid (e.g., deleted). In some cases, the metadata may include a repeated data bit (e.g., 1-bit indicator). In this example, the repeated data bit for this page indicates that the invalid page (e.g., deleted page) is not repeated data (e.g., binary 0, with null repeat value 0×0). As shown, this page is unwritten (e.g., page is clear based on being deleted; data in the page is invalid; page is ready to be written to).

As shown, the page validity bits of the page represented in the second row of Table 2 indicates this page is active (e.g., binary 01). Also, the repeated data bit in the second row indicates the active page is repeated data (e.g., binary 1, with repeat value 0×1). With the page being active, an application can continue to use that page for repeat data (e.g., for an FTL of an allocation associated with that page). Mappings of the FTL may be updated based on the updated data (e.g., rewriting blocks based on updating a data value, etc.). As shown, the page associated with the second row is unwritten. The page may be unwritten based on the page being associated with a repeated value (e.g., source value written to a first page and the page of the second row is a repeat of the source value).

As shown, the page validity bits of the page represented in the third row indicates this page is active (e.g., binary 01). Also, the repeated data bit in the third row indicates this active page is not repeated data (e.g., binary 0). As shown, this page includes a page of data (e.g., page is active and written to). For example, based on the data associated with the third row being original source data (e.g., not repeated data), the data may be stored in an associated page of data. If the data on this first page is updated, the updated data may be written to a second page and the FTL for this allocation may be updated to indicate the second page. The second page may be a new page of the same block (e.g., same block as the first page) or a new page of a different block.

As shown, the page validity bits of the page represented in the fourth row indicates this page is unused (e.g., binary 10). Also, the repeated data bit in the fourth row indicates this unused page is not repeated data (e.g., binary 0). As shown, this page is unwritten (e.g., page is clear, based on being unused).

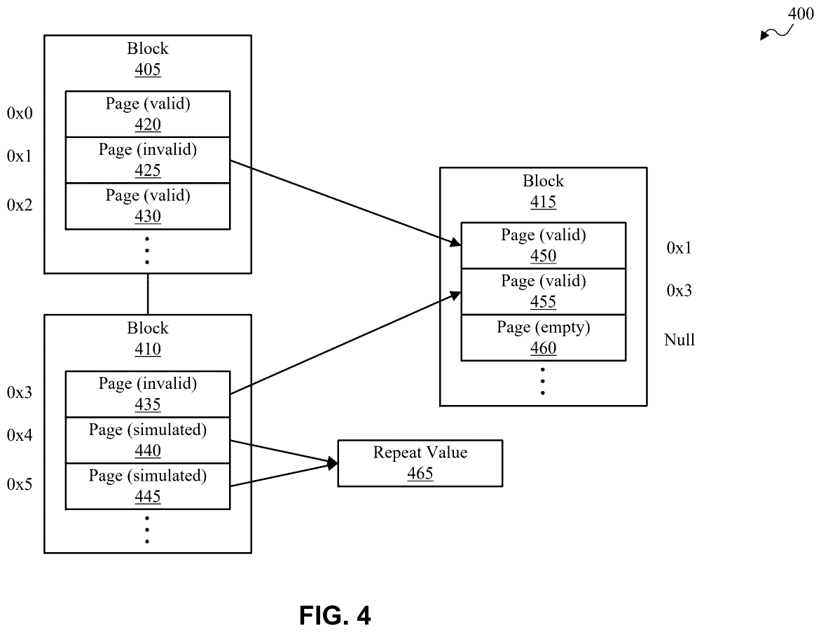

FIG. 4 illustrates example data blocks 400 in accordance with one or more implementations as described herein. In some configurations, one or more aspects of data blocks 400 may be implemented by or in conjunction with allocation controller 140 of FIG. 1 and/or allocation controller 230 of FIG. 2. In some configurations, one or more aspects of data blocks 400 may be implemented by or in conjunction with machine 105, components of machine 105, or any combination thereof. Data blocks 400 may depict blocks and pages of those blocks.

In some examples, data blocks 400 may depict a graphical representation of pages and blocks of an FTL of a given allocation. Allocations can include allocations of application data, user data, system data, etc. A given allocation may be a byte addressable allocation. In some cases, each 8-bit byte in an allocation may have its own unique memory address, which provides flexibility in working with variable-sized data. When a program allocates a data type larger than one byte, such as a 32-bit integer, the system can assign a sequence of consecutive byte addresses to that data. A given FTL may be generated for a given allocation. For example, a first FTL may be generated for a first allocation (e.g., allocation of data blocks 400), a second FTL may be generated for a second allocation, etc. Unused blocks may be included in a freelist, available for requested allocations. Active allocations of blocks may be tracked in an allocation list. When an allocation is terminated, the blocks of the allocation may be returned to the freelist, the FTL of that allocation may be terminated, and the allocation may be removed from the allocation list. Freed blocks may be added to the freelist in a round-robin configuration (e.g., in a cyclical, sequential order to provide even distribution). Additionally, or alternatively, the least recently used blocks may be provided for the next requested allocation.

In the illustrated example, data blocks 400 may include one or more blocks (e.g., block 405, block 410, block 415, etc.). As shown, block 405 may include page 420, page 425, page 430. Block 410 may include page 435, page 440, page 445. Block 415 may include page 450, page 455, page 460. Page 440 and page 445 may point to repeat value 465.

As shown, a given block may include multiple pages, each page may be associated with an address (e.g., 0×0, 0×1, 0×2, etc.). The addresses may be associated with physical addresses of a memory device. In some cases, the addresses may be presented to a host. A given page may map onto a valid block page.

As shown, page 420 and page 430 are valid pages of block 405 (e.g., page 420 and page 430 store data, respectively, at block 405). In the illustrated example, page 420 includes its own address (e.g., 0×0) that a controller may present to the host, and page 430 includes its own address (e.g., 0×2) that the controller may present to the host.

In some cases, a first page of a block (e.g., page 425; not necessarily a first page in order) may store valid data associated with an allocation. The FTL for this allocation may provide to the host an address used by the application for the data (e.g., 0×1) and a page ID for the first page (e.g., 0×44). Based on some operation (e.g., an operation of an application that received the allocation), the data at the first page may be updated. Accordingly, the updated version of this data may be stored at a second page (e.g., second page of the same block or of a different block). Accordingly, the original data at the first page becomes invalid, and the data at the second page is the valid state of the original data at the first page. Accordingly, the FTL for this allocation may provide to the host an address used by the application for this data (e.g., 0×1) at block 415 and a page ID for the second page (e.g., 0×55). As shown, page 425 is an invalid page of block 405. The data at page 425 is no longer be valid, and the valid version of this data is now located at page 450 of block 415. Accordingly, the FTL for this allocation may provide to the host an address used by the application for this data (e.g., 0×1, which may be a virtual address) and a page ID for page 450.

As shown, page 435 is an invalid page of block 410. As shown, the data at page 435 is no longer valid, and the valid version of this data is now located at page 455 of block 415. Accordingly, the FTL for this allocation may provide to the host an address used by the application for this data (e.g., 0×3, which may be a virtual address) and a page ID for page 455. As shown, page 460 may be an empty page of block 415, and thus the address of page 460 may be null.

As shown, page 440 and page 445 of block 410 may point to repeat value 465. For example, repeat value 465 may store some value (e.g., repeat value=0×3, binary 0111) and page 440 may simulate a first page of block 410 storing the value of repeat value 465. Similarly, page 445 may simulate a second page of block 410 storing the value of repeat value 465. In some cases, repeat value 465 may be stored in metadata and/or in a page of a block (e.g., a page of block 405, block 410, block 415, another block, etc., used to store metadata). The metadata may be stored on the memory device and/or another memory or storage device of the host.

As shown, the FTL for this allocation may provide the host the address for the simulated data of page 440 (e.g., 0×4, which may be a virtual address) and a page ID of the page holding repeat value 465. Similarly, the FTL for this allocation may provide the host the address for the simulated data of page 445 (e.g., 0×5, which may be a virtual address) and a page ID of the page holding repeat value 465.

In some examples, one or more blocks may be virtual blocks. For example, block 410 may be a virtual block tracked by a managing entity (e.g., allocator 315, memory controller 320) that is presented to the host as a physical block of the memory device. In some examples, pages may be tracked in metadata (e.g., metadata 325).

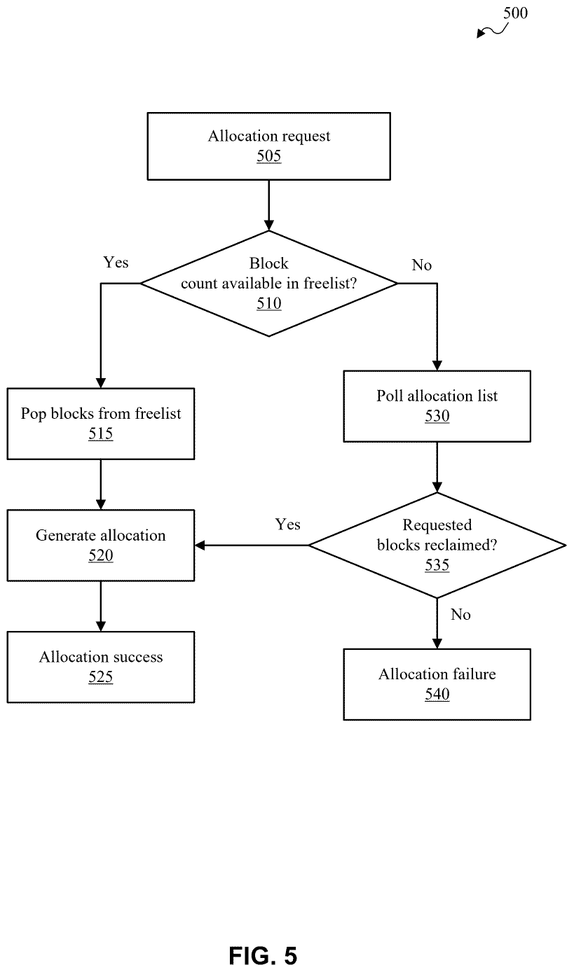

FIG. 5 depicts a flow diagram illustrating an example method 500 associated with the disclosed systems, in accordance with example implementations described herein. FIG. 5 depicts an allocation process. In some configurations, one or more aspects of method 500 may be implemented by or in conjunction with allocation controller 140 of FIG. 1 and/or allocation controller 230 of FIG. 2. In some configurations, one or more aspects of method 500 may be implemented by or in conjunction with machine 105, components of machine 105, or any combination thereof. The depicted method 500 is just one implementation, and one or more operations of method 500 may be rearranged, reordered, omitted, and/or otherwise modified such that other implementations are possible and contemplated.

At 505, method 500 may be associated with an allocation request (e.g., receiving an allocation request). For example, allocation controller 140 may include receiving a request from an application for an allocation of blocks (e.g., allocation of NAND blocks).

At 510, method 500 may include determining whether a block count is available in a freelist (e.g., list of blocks available for allocation). For example, allocation controller 140 may determine whether the freelist indicates that a number of blocks requested at 505 are available to be allocated.

At 515, method 500 may include popping blocks from the freelist. For example, when allocation controller 140 determines that the freelist indicates that the number of blocks requested at 505 are available, allocation controller 140 may pop from the freelist the blocks requested at 505.

At 520, method 500 may include generating the allocation. For example, allocation controller 140 may generate the allocation (e.g., generate an allocation FTL) requested at 505 based on popping the blocks from the freelist at 515.

At 525, method 500 may include indicating allocation success. For example, allocation controller 140 may indicate (e.g., to the application, to the host) that the allocation requested at 505 has been granted.

At 530, method 500 may include polling an allocation list (e.g., list of active FTL allocations). For example, when allocation controller 140 determines that the freelist indicates that the number of blocks requested at 505 are not available (e.g., not enough free blocks), allocation controller 140 may poll an allocation list (e.g., poll allocation list FTLs for block compaction). For example, allocation controller 140 may poll the allocation list to determine whether there are any reclaimable blocks among the active allocations

At 535, method 500 may include determining whether at least one block requested at 505 is reclaimed. For example, allocation controller 140 may determine whether at least one block requested at 505 is reclaimable, and then reclaim the at least one block upon determining the at least one block is reclaimable. When allocation controller 140 determines that the at least one block is reclaimed, allocation controller 140 may generate the allocation at 520. In some cases, allocation controller 140 may generate the allocation based on allocating one or more blocks from the freelist and/or based on allocating one or more reclaimed blocks at 535.

In example implementations, an application may request an allocation of 256 MB (e.g., two 128 MB blocks). Allocation controller 140 may determine that the freelist indicates 0 blocks or 1 block is available for allocation. Accordingly, as stated, allocation controller 140 may poll the allocation list to determine whether there are any reclaimable blocks among the active allocations (e.g., determine whether a given allocation is overusing blocks). For example, allocation controller 140 may identify an allocation of 128 MB (e.g., a 1-block allocation) that is using 3 blocks (e.g., based on out-of-place writes). Accordingly, allocation controller 140 may reclaim the overused blocks. For example, allocation controller 140 may compact the distributed data of this allocation down to one block, then free up the 3 blocks that had been used by this allocation.

At 540, method 500 may include indicating allocation failure. For example, when allocation controller 140 determines that the one or more blocks are not reclaimed, allocation controller 140 may indicate (e.g., to the application, to the host) that the allocation request has failed (e.g., out of memory failure). In some cases, allocation controller 140 may determine that the number of blocks reclaimed at 535 (e.g., in combination with any blocks indicated as available in the freelist) are insufficient to provide the one or more blocks requested at 505.

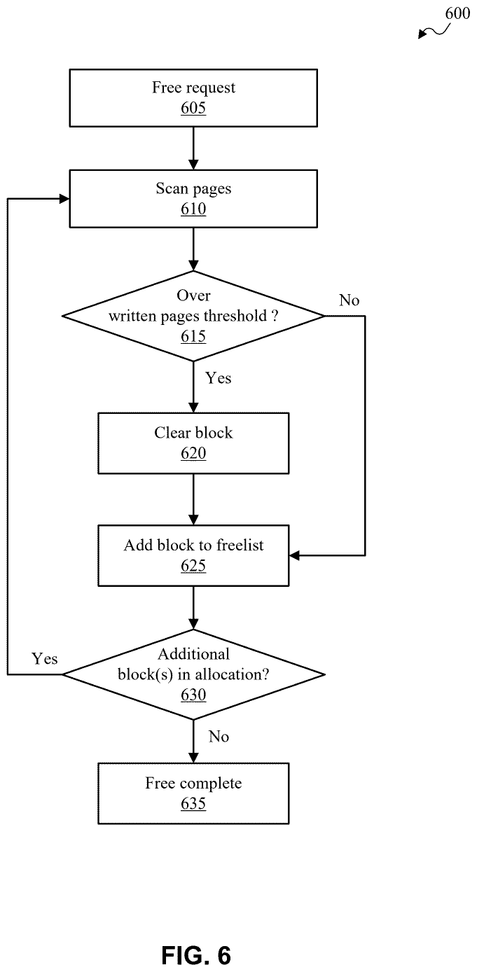

FIG. 6 depicts a flow diagram illustrating an example method 600 associated with the disclosed systems, in accordance with example implementations described herein. FIG. 6 depicts a de-allocation process. In some configurations, one or more aspects of method 600 may be implemented by or in conjunction with allocation controller 140 of FIG. 1 and/or allocation controller 230 of FIG. 2. In some configurations, one or more aspects of method 600 may be implemented by or in conjunction with machine 105, components of machine 105, or any combination thereof. The depicted method 600 is just one implementation, and one or more operations of method 600 may be rearranged, reordered, omitted, and/or otherwise modified such that other implementations are possible and contemplated.

At 605, method 600 may include receiving a free request (e.g., de-allocation request). For example, allocation controller 140 may receive (e.g., from an application or a host) a request to free an allocation indicated in the request.

At 610, method 600 may include scanning pages. For example, allocation controller 140 may scan one or more pages of the allocation for written values. In some cases, allocation controller 140 may scan one or more pages per block of the allocation (e.g., scan pages of a first block of the allocation, scan pages of a second block of the allocation, etc.).

At 615, method 600 may include determining whether the allocation is over a written pages threshold. For example, allocation controller 140 may determine whether the allocation is greater than (e.g., equal to or greater than) a written pages threshold. Determining whether the allocation is over a written pages threshold may allow for partial reuse of a block based on the block having a sufficient number of unwritten pages.

At 620, method 600 may include clearing the block. For example, when allocation controller 140 determines that the block is over the written pages threshold (e.g., more than some percentage of pages have been written to; over 40%, over 50%, over 60%, etc.) allocation controller 140 may clear the block. In some cases, the written pages threshold may be used to verify whether the block being freed is ready for a future allocation. For example, when more than 50% of the pages of the block have been written to, then the allocation controller 140 may clear the block.

At 625, method 600 may include adding the block to the freelist. For example, when allocation controller 140 determines that the block is not over the written pages threshold, allocation controller 140 may add the block to the freelist. Similarly, based on clearing the block at 620, allocation controller 140 may add the block to the freelist. In some cases, the block may be added to the freelist based on a round-robin allocation pattern (e.g., in a cyclical, sequential order to provide even distribution). Additionally, or alternatively, the block may be added to the freelist based on using a least recently used block for a next allocation.

At 630, method 600 may include determining whether there are additional blocks in the allocation. For example, allocation controller 140 may determine whether there are additional blocks in the allocation left to be freed. When allocation controller 140 determines that there are additional blocks in the allocation left to be freed, method 600 may return to 610 and proceed accordingly. For each additional block in the allocation, allocation controller 140 may perform one or more depicted operations of method 600.

At 635, method 600 may include indicating the requested free operation is completed. For example, when allocation controller 140 determines that there are no additional blocks in the allocation left to be freed, allocation controller 140 may indicate (e.g., to an application, to a host) that the requested free operation is completed.

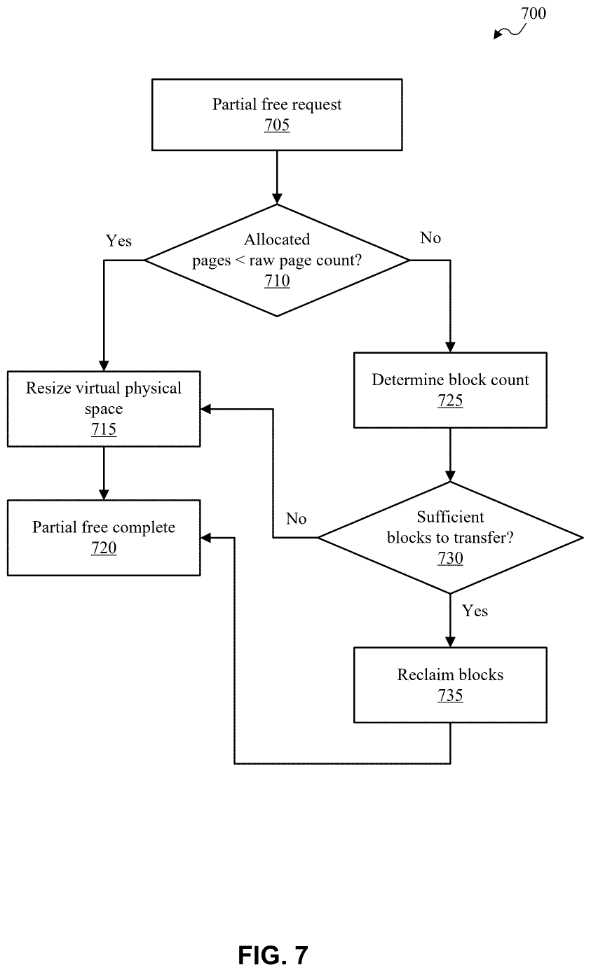

FIG. 7 depicts a flow diagram illustrating an example method 700 associated with the disclosed systems, in accordance with example implementations described herein. FIG. 7 depicts a process to free at least a portion of an allocation. In some configurations, one or more aspects of method 700 may be implemented by or in conjunction with allocation controller 140 of FIG. 1 and/or allocation controller 230 of FIG. 2. In some configurations, one or more aspects of method 700 may be implemented by or in conjunction with machine 105, components of machine 105, or any combination thereof. The depicted method 700 is just one implementation, and one or more operations of method 700 may be rearranged, reordered, omitted, and/or otherwise modified such that other implementations are possible and contemplated.

At 705, method 700 may include receiving a partial free request. For example, allocation controller 140 may receive (e.g., from an application, from a host) a request to free a portion of an active allocation. For example, an application or host may request a reallocation based on allocation usage decreasing, based on allocation demand decreasing, based on allocation usage being less than expected, etc.

At 710, method 700 may include determining whether a number of allocated pages is less than (e.g., less than or equal to) a raw page count. For example, allocation controller 140 may determine whether the number of pages allocated (e.g., number of pages currently being used) is less than a raw page count (e.g., the number of pages requested by the application).

At 715, method 700 may include resizing a virtual physical space. For example, when allocation controller 140 determines that the number of pages allocated are less than a raw page count (e.g., number of pages used are less than number of pages allocated), allocation controller 140 may resize a virtual physical space associated with the allocation. In some cases, allocation controller 140 may resize the physical address space for that allocation (e.g., reduce the physical address space for that allocation). In some cases, the host (e.g., operating system) may handle the mapping of virtual memory to physical address space (e.g., based on resizing the physical address space).

At 720, method 700 may include indicating the partial free request is complete. For example, allocation controller 140 may indicate (e.g., to the application, to the host) that the partial free request has completed successfully.

At 725, method 700 may include determining the requested block count. For example, when allocation controller 140 determines that the number of pages allocated are greater than (e.g., not less than) a raw page count (e.g., number of pages used are not less than number of pages allocated), allocation controller 140 may determine a block count associated with the partial free request.

At 730, method 700 may include determining whether there are sufficient blocks to transfer. For example, allocation controller 140 may determine, based on the partial free request, whether there are sufficient blocks available to transfer for the requested block count.

At 735, method 700 may include reclaiming one or more blocks. For example, when allocation controller 140 determines that there are sufficient blocks to transfer, allocation controller 140 may reclaim a number of blocks based on the partial free request. In some cases, one or more operations may be associated with allocation controller 140 reclaiming the one or more block. For example, for a given reclamation, allocation controller 140 may transfer pages, free blocks, update FTLs, and/or add blocks to the freelist, etc. In some cases, when the number of pages that are allocated is less than the raw page count, then allocation controller 140 may transfer the live pages of a given block (e.g., transfer pages from a first block to a second block). In some examples, reclaiming may include allocation controller 140 freeing one or more blocks (e.g., transferring a live page from a first block to a second block, freeing the first block, etc.). In some cases, reclaiming may include allocation controller 140 updating at least one FTL of a given allocation (e.g., update metadata to indicate the updated blocks). In some cases, reclaiming may include allocation controller 140, adding the one or more freed blocks to the freelist. In some cases, method 700 may proceed to 720 from 735 to indicate the partial free request is completed.

In some cases, there may not be sufficient blocks to transfer a portion of blocks from one allocation to another (e.g., based on the partial free request). As shown, when allocation controller 140 determines that there are insufficient blocks to transfer, method 700 may proceed to 715. In some cases, when allocation controller 140 determines that there are sufficient blocks to transfer, there may not be sufficient additional blocks to perform the transfer (e.g., because the blocks may be updated out of place). For example, a partial free request may request that an allocation be reduced from 128 MB to 64 MB based on the allocation having 64 MB of written pages, where the allocation may be resized to 64 MB. However, method 700 may proceed to 715 because allocation controller 140 determines there are insufficient additional blocks to perform the transfer. For example, to transfer live pages from a first block to a second block, the second block must be available, and if allocation controller 140 determines the second block (e.g., no free blocks available for partial free operations), then method 700 may proceed to 715.

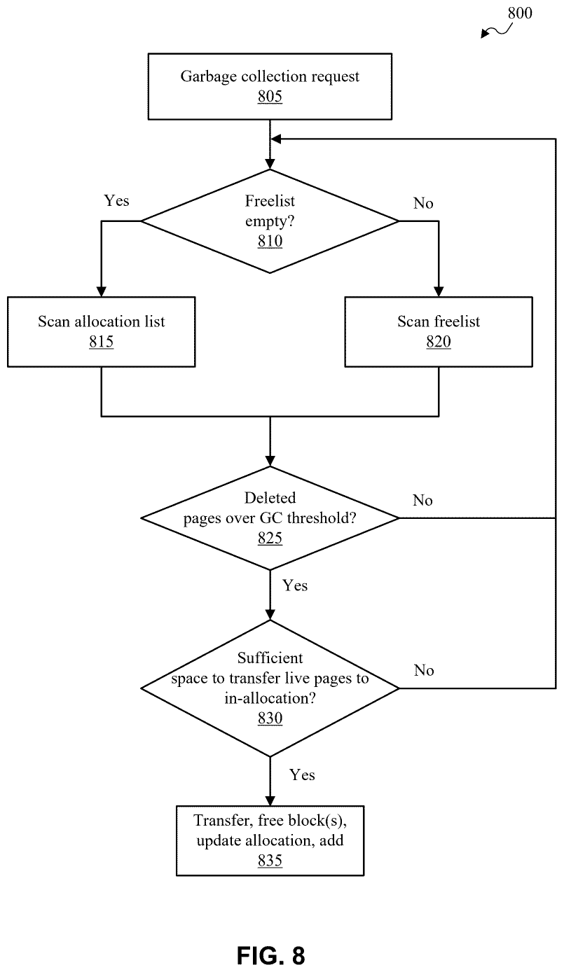

FIG. 8 depicts a flow diagram illustrating an example method 800 associated with the disclosed systems, in accordance with example implementations described herein. FIG. 8 depicts a compaction or garbage collection process. In particular, FIG. 8 describes an in-allocation garbage collection instead of a global garbage collection of an entire heap. For example, the in-allocation garbage collection may be configured to a given allocation. In some configurations, one or more aspects of method 800 may be implemented by or in conjunction with allocation controller 140 of FIG. 1 and/or allocation controller 230 of FIG. 2. In some configurations, one or more aspects of method 800 may be implemented by or in conjunction with machine 105, components of machine 105, or any combination thereof. The depicted method 800 is just one implementation, and one or more operations of method 800 may be rearranged, reordered, omitted, and/or otherwise modified such that other implementations are possible and contemplated.

In NAND flash memory, invalid pages (e.g., deleted pages, pages that are no longer in use) may be marked and eventually removed as part of a process called garbage collection. Garbage collection may be performed when the number of invalid pages in a block reaches some threshold (e.g., greater than 25%; equal to or greater than 25%, or some other percentage, such as 30%, 40%, 50%, etc.). Garbage collection can help extend the lifespan of NAND memory by consolidating valid data and invalidating obsolete pages.

At 805, method 800 may include receiving a garbage collection request. For example, allocation controller 140 may receive (e.g., from an application, from the host) a request for garbage collection.

At 810, method 800 may include determining whether the freelist is empty. For example, allocation controller 140 may determine whether the freelist is empty based on the garbage collection request. In some cases, when the freelist has a sufficient number of blocks (e.g., number of blocks in freelist meets or exceeds a threshold number of blocks), the allocation list does not get scanned.

At 815, method 800 may include scanning the allocation list. For example, when allocation controller 140 determines that the freelist is empty (e.g., no blocks available for allocation), allocation controller 140 may scan the allocation list based on the garbage collection request.

At 820, method 800 may include scanning the freelist. For example, when allocation controller 140 determines that the freelist is not empty (e.g., blocks available for allocation), allocation controller 140 may scan the freelist based on the garbage collection request.

At 825, method 800 may include determining whether a number of invalid pages is over a garbage collection threshold. For example, allocation controller 140 may determine whether the number of invalid pages (e.g., deleted pages) in a given block satisfies (e.g., is greater than, greater than or equal to) a garbage collection threshold (e.g., compaction threshold of 25%, 35%, 50%, etc.). In some examples, allocation controller 140 may determine that at least 25% of the pages in a first block are invalid. Allocation controller 140 may then compact the first block, which may include allocation controller 140 transferring valid pages of the first block to a second block and freeing the first block. It is noted that pages may not be transferred when a block is invalid. As shown, when allocation controller 140 determines that the number of invalid pages in a block does not satisfy the garbage collection threshold, method 800 may return to 810 (e.g., to analyze a next block).

At 830, method 800 may include determining whether there is sufficient space to transfer valid pages in an allocation. For example, when allocation controller 140 determines that the number of invalid pages in a given block satisfies the garbage collection threshold, allocation controller 140 may determine whether there is sufficient space (e.g., a free block) within the allocation to which the valid pages may be transferred. When allocation controller 140 determines that there is not sufficient space to transfer the valid pages (e.g., no available block to receive the valid pages), method 800 may return to 810.

At 835, method 800 may include reclaiming one or more blocks. For example, when allocation controller 140 determines that there is sufficient space to transfer the one or more valid pages of a block, allocation controller 140 may reclaim that block. For example, allocation controller 140 may transfer one or more valid pages from a first block to a second block, and then free the first block. In some cases, allocation controller 140 may update an FTL based on transferring the pages to the second block, indicating that the second block now holds the transferred pages. In some cases, allocation controller 140 may add the first block to the freelist based on copying the valid pages from the first block to the second block. In some cases, allocation controller 140 may remove any references to pages in the block being freed, clear the block, and add the block to the freelist. In some cases, allocation controller 140 may continue performing operations of method 800 until all the blocks of at least one allocation of the allocation list are scanned and/or until all the blocks of the freelist are scanned. Once completed, allocation controller 140 may indicate the garbage collection request is completed.

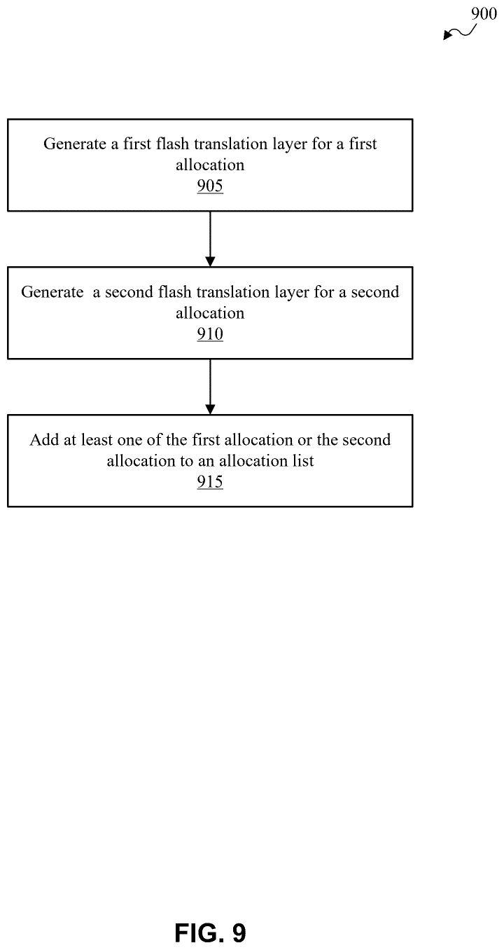

FIG. 9 depicts a flow diagram illustrating an example method 900 associated with the disclosed systems, in accordance with example implementations described herein. FIG. 9 describes a process of byte-addressable NAND memory. In some configurations, one or more aspects of method 900 may be implemented by or in conjunction with allocation controller 140 of FIG. 1 and/or allocation controller 230 of FIG. 2. In some configurations, one or more aspects of method 900 may be implemented by or in conjunction with machine 105, components of machine 105, or any combination thereof. The depicted method 900 is just one implementation, and one or more operations of method 900 may be rearranged, reordered, omitted, and/or otherwise modified such that other implementations are possible and contemplated.

At 905, method 900 may include generating a first flash translation layer for a first allocation. For example, allocation controller 140 may generate a first flash translation layer for a first allocation of a memory device.

At 910, method 900 may include generating a second flash translation layer for a second allocation. For example, allocation controller 140 may generate a second flash translation layer for a second allocation of the memory device, the first allocation and the second allocation being based on a pool of allocation space indicated in a freelist (e.g., a list of one or more blocks free for allocation).

At 915, method 900 may include adding at least one of the first allocation or the second allocation to an allocation list. For example, allocation controller 140 may add at least one of the first allocation or the second allocation to an allocation list (e.g., a list of active allocations) based on generating at least one of the first flash translation layer or the second flash translation layer.

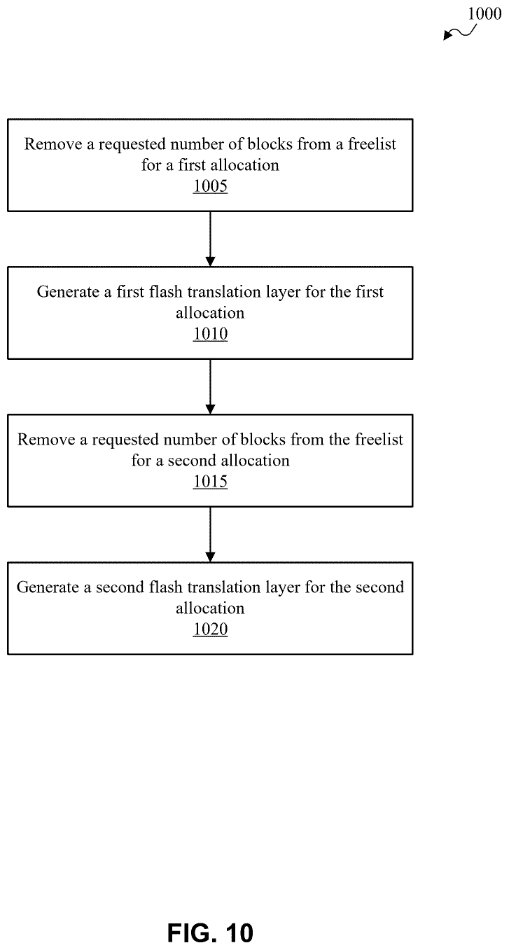

FIG. 10 depicts a flow diagram illustrating an example method 1000 associated with the disclosed systems, in accordance with example implementations described herein. FIG. 10 describes a process of byte-addressable NAND memory. In some configurations, one or more aspects of method 1000 may be implemented by or in conjunction with allocation controller 140 of FIG. 1 and/or allocation controller 230 of FIG. 2. In some configurations, one or more aspects of method 1000 may be implemented by or in conjunction with machine 105, components of machine 105, or any combination thereof. The depicted method 1000 is just one implementation, and one or more operations of method 1000 may be rearranged, reordered, omitted, and/or otherwise modified such that other implementations are possible and contemplated.

At 1005, method 1000 may include removing (e.g., popping) a requested number of blocks from a freelist for a first allocation. For example, allocation controller 140 may receive a request from an application for some number of blocks. When allocation controller 140 determines the freelist includes at least the number of blocks requested, allocation controller 140 may pop the requested number of blocks from the freelist for the first allocation. In some cases, allocations may be provided by the freelist based on a round-robin scheduling (e.g., requested blocks popped from head or tail; freed blocks added to tail or head).

At 1010, method 1000 may include generating a first flash translation layer for a first allocation of a memory device. For example, allocation controller 140 may generate a first flash translation layer for a first allocation of a memory device. In some cases, allocation controller 140 may add the first allocation to an allocation list based on generating the first flash translation layer.

At 1015, method 1000 may include removing (e.g., popping) a requested number of blocks from the freelist for a second allocation. For example, allocation controller 140 may pop a requested number of blocks from the freelist for the second allocation.

At 1020, method 1000 may include generating a second flash translation layer for the second allocation. For example, allocation controller 140 may generate a second flash translation layer for a second allocation of the memory device. In some cases, allocation controller 140 may add the second allocation to the allocation list based on generating the second flash translation layer.

In the examples described herein, the configurations and operations are example configurations and operations, and may involve various additional configurations and operations not explicitly illustrated. In some examples, one or more aspects of the illustrated configurations and/or operations may be omitted. In some embodiments, one or more of the operations may be performed by components other than those illustrated herein. Additionally, or alternatively, the sequential and/or temporal order of the operations may be varied.

Certain embodiments may be implemented in one or a combination of hardware, firmware, and software. Other embodiments may be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wired and/or wireless communication device such as a switch, router, network interface controller, cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be wireless, wired, mobile, and/or stationary.

As used within this document, the term “communicate” is intended to include transmitting, or receiving, or both transmitting and receiving. Similarly, the bidirectional exchange of data between two devices (both devices transmit and receive during the exchange) may be described as ‘communicating’, when only the functionality of one of those devices is being claimed. The term “communicating” as used herein with respect to wired and/or wireless communication signals includes transmitting the wired and/or wireless communication signals and/or receiving the wired and/or wireless communication signals. For example, a communication unit, which is capable of communicating wired and/or wireless communication signals, may include a wired/wireless transmitter to transmit communication signals to at least one other communication unit, and/or a wired/wireless communication receiver to receive the communication signal from at least one other communication unit.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infrared (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth™, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Although an example processing system has been described above, embodiments of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more components of computer program instructions, encoded on computer storage medium for execution by, or to control the operation of, information/data processing apparatus. Alternatively, or in addition, the program instructions can be encoded on an artificially-generated propagated signal, for example, a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (for example, multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example, an FPGA or an ASIC. The apparatus can also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a component, component, subroutine, object, or other unit suitable for use in a computing environment. A computer program may, but need not, correspond to a file in a file system. A program can be stored in a portion of a file that holds other programs or information/data (for example one or more scripts stored in a markup language document), in a single file dedicated to the program in question, or in multiple coordinated files (for example files that store one or more components, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, for example magnetic, magneto-optical disks, or optical disks. However, a computer need not have such devices. Devices suitable for storing computer program instructions and information/data include all forms of non-volatile memory, media and memory devices, including by way of example semiconductor memory devices, for example EPROM, EEPROM, and flash memory devices; magnetic disks, for example internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, for example, a CRT (cathode ray tube) or LCD (liquid crystal display) monitor, for displaying information/data to the user and a keyboard and a pointing device, for example, a mouse or a trackball, by which the user can provide input to the computer. Other kinds of devices can be used to provide for interaction with a user as well; for example, feedback provided to the user can be any form of sensory feedback, for example visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, for example, as an information/data server, or that includes a middleware component, for example, an application server, or that includes a front-end component, for example, a client computer having a graphical user interface or a web browser through which a user can interact with an embodiment of the subject matter described herein, or any combination of one or more such back-end, middleware, or front-end components. The components of the system can be interconnected by any form or medium of digital information/data communication, for example, a communication network. Examples of communication networks include a local area network (“LAN”) and a wide area network (“WAN”), an inter-network (for example the Internet), and peer-to-peer networks (for example ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (for example, an HTML page) to a client device (for example, for purposes of displaying information/data to and receiving user input from a user interacting with the client device). Information/data generated at the client device (for example, a result of the user interaction) can be received from the client device at the server.

While this specification contains many specific embodiment details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying FIGURES do not necessarily require the particular order shown, or sequential order, to achieve desirable results. In certain embodiments, multitasking and parallel processing may be advantageous.

Many modifications and other examples as set forth herein will come to mind to one skilled in the art to which these embodiments pertain to having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A method comprising:
generating a first flash translation layer for a first allocation of a memory device;
generating a second flash translation layer for a second allocation of the memory device, the first allocation and the second allocation being based on a pool of allocation space indicated in a freelist; and
adding at least one of the first allocation or the second allocation to an allocation list based on generating at least one of the first flash translation layer or the second flash translation layer.

2. The method of claim 1, further comprising:
determining that the freelist indicates a requested number of blocks are available for the first allocation; and
removing the requested number of blocks from the freelist for the first allocation,
wherein allocations are provided by the freelist based on least recently used blocks.

3. The method of claim 1, further comprising:
polling a list of allocations on the memory device based on a requested number of blocks for the second allocation being unavailable;
performing garbage collection on a third allocation of the memory device based on the polling; and
reclaiming, at least one block from the third allocation.

4. The method of claim 1, further comprising:
scanning a block of a fourth allocation for values written to pages of the block;
clearing the block based on a number of pages of the block satisfying a written pages threshold; and
adding the block to the freelist based on clearing the block.

5. The method of claim 1, further comprising:
determining a number of pages used by a third allocation is less than a number of pages allocated to the third allocation; and
transferring at least one of the pages used by the third allocation from a first block of the third allocation to a second block of the third allocation.

6. The method of claim 5, further comprising:
adding the first block of the third allocation to the freelist based on freeing the first block of the third allocation; and
updating a flash translation layer of the third allocation based on the transferring the at least one of the pages and the adding the first block of the third allocation to the freelist.

7. The method of claim 1, further comprising:
determining a number of invalid pages satisfies a garbage collection threshold;
transferring pages of a first block and a second block of a fifth allocation to a third block of the fifth allocation; and
adding the first block and the second block of the fifth allocation to the freelist.

8. The method of claim 1, further comprising:
scanning the freelist based on the freelist indicating memory space available for allocations;
determining a number of deleted pages satisfies a garbage collection threshold;
transferring pages of a first block and a second block of a sixth allocation to a third block of the sixth allocation; and
adding the first block and the second block of the sixth allocation to the freelist.

9. The method of claim 1, further comprising:
storing a value in a first page of the first allocation; and
storing a pointer to the value in a second page of the first allocation based on a second instance of the value being used by an application associated with the first allocation.

10. The method of claim 1, wherein an allocation controller of the memory device generates flash translation layers of the memory device.

11. The method of claim 1, wherein:
a memory controller of the memory device generates flash translation layers of the memory device, and
the memory device comprises a NAND flash memory device.

12. The method of claim 1, wherein:
the freelist includes a list of blocks available for allocation, and
the allocation list includes a list of blocks being allocated.

13. A device comprising:
one or more processors; and
memory storing instructions that, when executed by the one or more processors, cause the device to:
generate a first flash translation layer for a first allocation of a memory device;
generate a second flash translation layer for a second allocation of the memory device, the first allocation and the second allocation being based on a pool of allocation space indicated in a freelist; and
add at least one of the first allocation or the second allocation to an allocation list based on generating at least one of the first flash translation layer or the second flash translation layer.

14. The device of claim 13, wherein the instructions, when executed by the one or more processors, further cause the device to:
determine that the freelist indicates a requested number of blocks are available for the first allocation; and
remove the requested number of blocks from the freelist for the first allocation,
wherein allocations are provided by the freelist based on round-robin scheduling.

15. The device of claim 13, wherein the instructions, when executed by the one or more processors, further cause the device to:
poll a list of allocations on the memory device based on a requested number of blocks for the second allocation being unavailable;
perform garbage collection on a third allocation of the memory device based on the polling; and
reclaim, for the second allocation, at least one block from the third allocation.

16. The device of claim 13, wherein the instructions, when executed by the one or more processors, further cause the device to:
scan a block of a fourth allocation for values written to pages of the block;
clear the block based on a number of pages of the block satisfying a written pages threshold; and
add the block to the freelist based on clearing the block.

17. The device of claim 13, wherein the instructions, when executed by the one or more processors, further cause the device to:
determine a number of pages used by a third allocation is less than a number of pages allocated to the third allocation; and
transfer at least one of the pages used by the third allocation from a first block of the third allocation to a second block of the third allocation.

18. A non-transitory computer-readable medium storing code that comprises instructions executable by a processor of to:
generate a first flash translation layer for a first allocation of a memory device;
generate a second flash translation layer for a second allocation of the memory device, the first allocation and the second allocation being based on a pool of allocation space indicated in a freelist; and
add at least one of the first allocation or the second allocation to an allocation list based on generating at least one of the first flash translation layer or the second flash translation layer.

19. The non-transitory computer-readable medium of claim 18, wherein the code includes further instructions executable by the processor to:
determine that the freelist indicates a requested number of blocks are available for the first allocation; and
remove the requested number of blocks from the freelist for the first allocation,
wherein allocations are provided by the freelist based on round-robin scheduling.

20. The non-transitory computer-readable medium of claim 18, wherein the code includes further instructions executable by the processor to:
poll a list of allocations on the memory device based on a requested number of blocks for the second allocation being unavailable;
perform garbage collection on a third allocation of the memory device based on the polling; and
reclaim, for the second allocation, at least one block from the third allocation.
